(19) United States
(12) Patent Application Publication
(10) Pub. No.: US 2015/0328663 A1
(43) Pub. Date: Nov. 19, 2015

(54) METHODS AND SYSTEMS FOR MOISTURE REVEALED INDICIA ON GLASS AND OTHER SURFACES

(71) Applicant: Michael Lawrence Abbot, New London, CT (US)

(72) Inventor: Michael Lawrence Abbot, New London, CT (US)

(21) Appl. No.: 14/707,714

(22) Filed: May 8, 2015

Related U.S. Application Data
(60) Provisional application No. 61/992,335, filed on May 13, 2014.

(51) Int. Cl. B05D 5/08; B05D 1/32; B44C 1/22; B05D 5/00

(52) U.S. Cl. CPC B05D 5/08; B05D 5/00; B05D 1/32; B44C 1/22

(57) ABSTRACT

A method for applying moisture revealed indicia to glass and other surfaces is provided. In some embodiments, the method may include: polishing a surface; changing the moisture condensing properties of portions of the surface by applying a surface tension modifier agent to those portions of the surface; and polishing the portions of the surface to which the surface tension modifier agent has been applied. Upon exposure of the surface to moisture, such as in the form of steam generated by the use of hot water in the vicinity of the surface or by steam generators, portions of the moisture revealed indicia may be formed by moisture revealed contrast

### CROSS REFERENCE TO RELATED APPLICATIONS

This application claims priority to and the benefit of the filing date of U.S. Provisional Application No. 61/992,335, filed on May 13, 2014, entitled “METHODS AND SYSTEMS FOR MOISTURE REVEALED INDICIA ON GLASS AND OTHER SURFACES”, which is hereby incorporated by reference in its entirety.

### FIELD OF THE INVENTION

This patent specification relates to the field of indicia application. More specifically, this patent specification relates to systems and methods of applying indicia to surfaces in which the applied indicia is revealed upon contact with moisture.

### BACKGROUND

Application of indicia to surfaces is known in the art. Indicia may include designs, pictures, symbols, graphic representations, and other graphics, words, letters, numbers, and any other written communication. Application of indicia may serve a plurality of purposes such as to provide information, advertisements, directions, entertainment, visual appeal, visual aesthetics, and other like purposes.

In light of all the purposes application of indicia may serve, there is an ever present need for novel methods of application to promote notice of indicia by an observer. Applications that provide moving forms of indicia such as scrolling words or symbols are common and therefore over looked by observers and require expensive electronics and power sources. Applications that temporarily induce indicia to appear and disappear such as flashing lights and signs have also been prone to be over looked by observers in addition to also requiring expensive electronics and power sources.

While electronic applications of indicia may provide moving and temporarily displayed indicia, the electronics required for their display obscures the surface over which they are positioned. Electronic signs placed in windows or over mirrors typically obstruct the view through the windows and mirrors, which may prevent people from seeing reflections or through and glass doors and windows. Since seeing through windows, mirrors, and glass doors is integral to their purpose, applications of indicia to these surfaces have been limited in size and scope. Since windows, glass doors, glass counters, mirrors, and other like surface are frequently encountered, this represents a significant loss of real estate that indicia can be applied to.

Therefore, a need exists for novel indicia application methods. There also exists a need for novel methods of application to promote notice of indicia by an observer. There is a further need for novel indicia applications that do not require expensive electronics and power sources. Finally, there exists a need for novel indicia applications that do not obscure the surface over which they are positioned.

### BRIEF SUMMARY OF THE INVENTION

According to one aspect consistent with the principles of the invention, a method for applying moisture revealed indicia to glass and other surfaces is provided. The method may include: polishing a surface; changing the moisture condensing properties of portions of the surface by applying a surface tension modifier agent to those portions of the surface; and polishing the portions of the surface to which the surface tension modifier agent has been applied. Upon exposure of the surface to moisture, such as in the form of steam generated by the use of hot water in the vicinity of the surface, portions of the moisture revealed indicia may be formed by the moisture revealed contrast between areas of the surface that have been coated with one or more surface tension modifier agents against areas of the surface that have not been coated with one or more surface tension modifier agents.

In further embodiments, a method for applying moisture revealed indicia to portions of a surface may include: polishing a surface; masking portions of the surface from contact with a surface tension modifier agent; changing the moisture condensing properties of portions of the surface by applying a surface tension modifier agent to those portions of the surface; and polishing the portions of the surface to which the surface tension modifier agent has been applied.

In further embodiments, the surface tension modifier agent may be water repellent and may be selected from the group consisting of hydrolyzed polydimethylsiloxane, chlorotrimethylsilane, isobutyltrimethoxysilane, monomeric alkylalkoxysiloxane, polysiloxanes, and, dimethylsiloxane.

In still further embodiments, portions of the surface to which the surface tension modifier agent has been applied may be polished with a super fine grade or an ultra fine grade polish.

In still further embodiments, the method may also comprise the application of two or more different surface tension modifier agents which may comprise different condensed water droplet size properties and result in different visual properties of a surface comprising a respective surface tension modifier.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a flowchart of an example of a method according to various embodiments described herein.

FIG. 2 illustrates a flowchart of an example of a method according to various embodiments described herein.

FIG. 3 shows a perspective view of an example of a stencil applied to an application surface according to various embodiments described herein.

FIG. 4 depicts a perspective view of an example of stencil backing being removed from an application surface according to various embodiments described herein.

FIG. 5 illustrates a perspective view of an example of a surface tension modifier agent being applied to an application surface according to various embodiments described herein.

FIG. 6 shows a perspective view of an example of excess cured surface tension modifier on an application surface after the stencil has been removed according to various embodiments described herein.

FIG. 7 shows a perspective view of an example of a moisture revealed indicia system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New systems and methods of applying indicia to surfaces in which the applied indicia is revealed upon contact with moisture are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

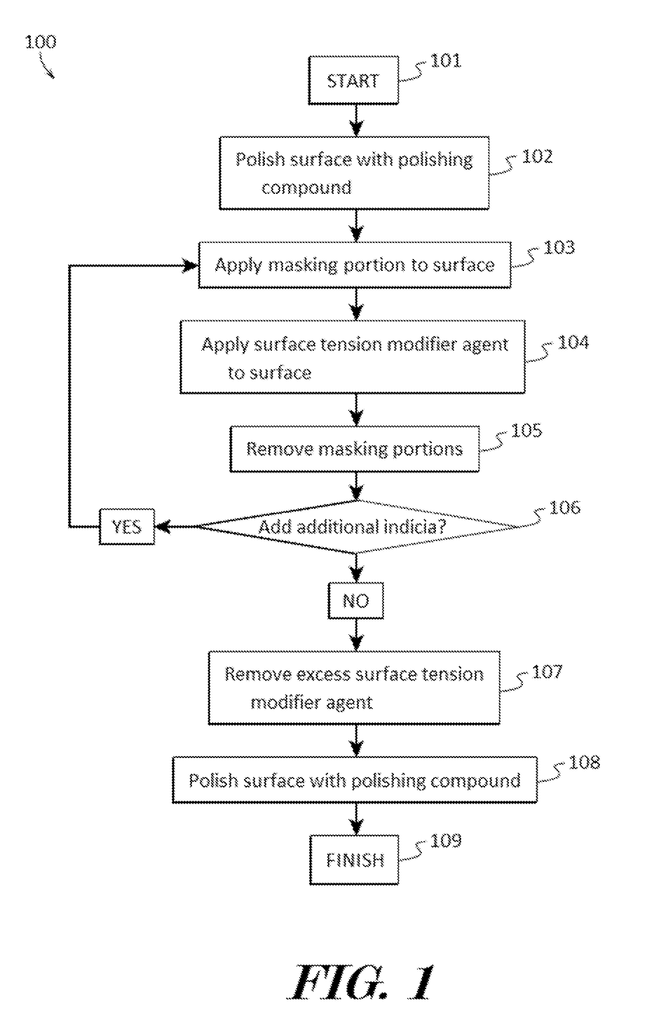

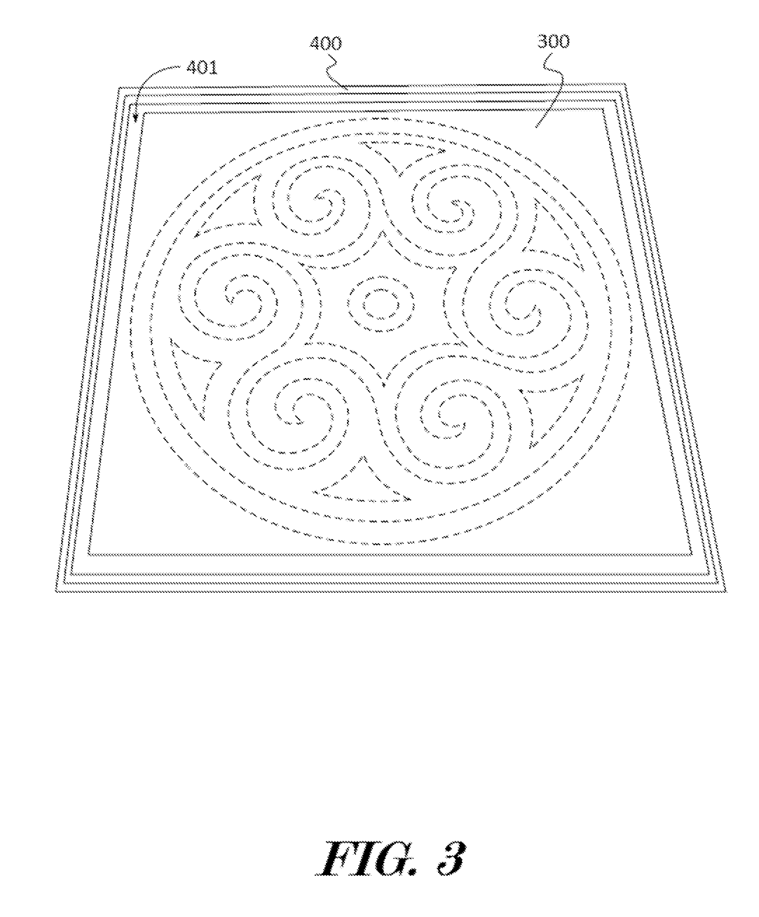

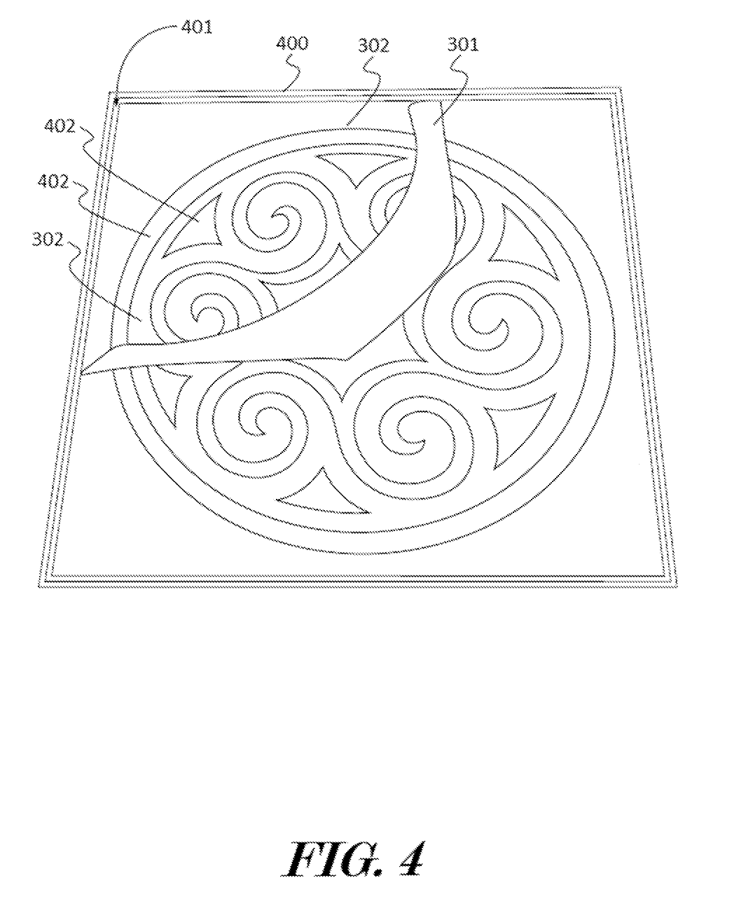

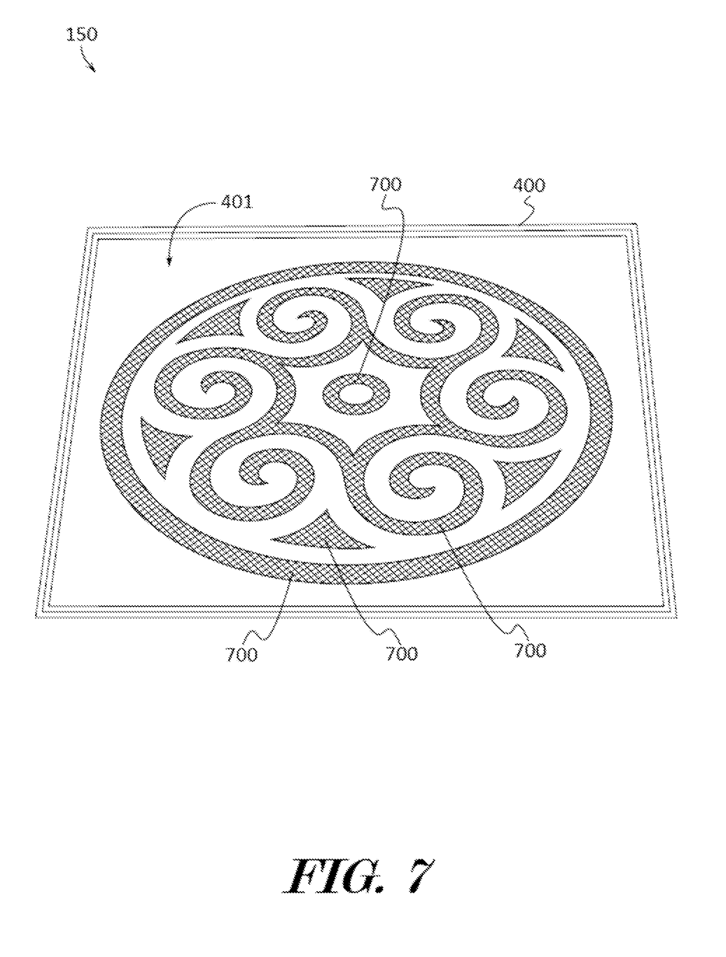

The present invention will now be described by example and through referencing the appended figures representing some preferred and alternative embodiments. FIG. 1 illustrates an example of a method for moisture revealed indicia application for glass and other surfaces (“the method”) 100 according to various embodiments. In this example, the method 100 comprises the use of a stencil 300 (FIGS. 3 and 4) to apply moisture revealed indicia 700 (FIG. 7) to an application surface 401 (FIGS. 3-7) which may visually appear when the application surface 401 is exposed to moisture. In some embodiments, the application surface 401 of the method 100 may comprise any surface which may be glossy or semi-glossy in finish and may optionally comprise a transparent or translucent material such as glass, plastics, resins, or any other substantially transparent material. Substantially transparent application surfaces 401 which may be exposed to moisture include beverage cups and containers, store and other windows, counters and counter tops, shower, spa and sauna glass walls and doors, other glass doors, skylights, lighting fixtures, mirrors, plastic sheeting, plastic films, or any other like surface. In other embodiments, the application surface 401 may be glossy or semi-glossy in finish and may optionally comprise a material that is not substantially transparent such as stone, ceramics, wood, metal surfaces, colored glass, frosted glass, translucent glass, translucent plastics, colored translucent plastics, or any other substantially translucent or non-transparent material. Application surfaces which are not substantially transparent and may be exposed to moisture include, walls, food service utensils, counters and counter tops, or any other like surface.

The method 100 may start 101 once an application surface 401 (FIGS. 3-7) is selected for indicia application. Next, the application surface 401 may be polished with a polishing compound in step 102. In some embodiments, the application surface 401 may be polished with an ultra fine (ISO/FEPA Grit designations P1500, P2000, P2500, P3000, P6000), super fine (ISO/FEPA Grit designations P800, P1000, P1200), or extra fine (ISO/FEPA Grit designations P400, P500, P600) grade polishing compound. In further embodiments, 3M Finesse-it Polish 28696 or any other similar polishing compound may be used to polish the application surface 401. In still further embodiments, the polishing compound may be applied to the application surface 401 with an air, electric, or any other type of buffer equipped with foam, wool, or any other suitable type of buffing pads. Once the application surface 401 has been polished, the residual polishing compound may be removed from the application surface 401 with a method common to the type of polishing compound used.

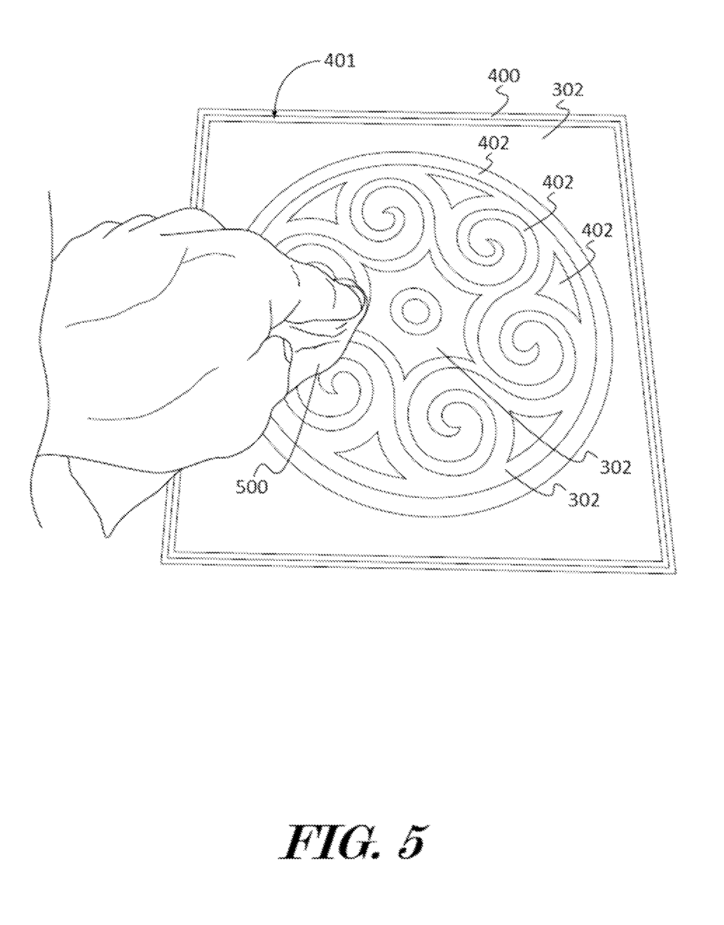

In step 103, masking portions 302 (FIGS. 4 and 5) such as from a stencil 300 (FIGS. 3 and 4) may be applied to the application surface 401 (FIGS. 3-7) to mask areas of the surface that are desired to have different condensation properties than the areas that are exposed to a surface tension modifier agent in step 104. In some embodiments, one or more masking portions 302 (FIGS. 4 and 5) may be provided by a stencil 300, tape, or any other type of mask which is configured to adhere to the application surface 401 thereby preventing a surface tension modifier agent from contacting those portions of the application surface 401 to which the masking portions 302 are adhered to. The masking portions 302 may be used to prevent areas of the application surface 401 from being left exposed to a surface tension modifier agent which may be applied in step 104.

After the masking portions 302 (FIGS. 4 and 5) of the stencil 300 (FIGS. 3 and 4) are adhered to the application surface 401 (FIGS. 3-7), a surface tension modifier agent may be applied onto desired areas of the application surface 401. The adhesive backing of the masking portions 302 may prevent surface tension modifier agent from contacting areas of the application surface 401 to which the masking portions 302 have been applied. The surface tension modifier agent may be applied free hand by an applicator 500 (FIG. 5) such as a pen, brush, marker, rubbing cloth, rubbing pad, or other implement or by a mechanical method such as an ink pad type of device, ink jet type applicator or printer, air brush sprayer, lamination, or any other application method.

A surface tension modifier agent may comprise any substance that is capable of altering the ability of moisture such as water, water droplets, water vapor, other liquids such as beverages, or any other aqueous solution to condense or adhere to a surface. Surface tension modifier agents may be applied to an application surface 401 (FIGS. 3-7) as a liquid, vapor, or solid which may become bonded to the application surface 401 once it dries or cures. In some embodiments, a surface tension modifier agent may comprise water repellant properties and may be capable of reducing the condensed water droplet size on the surface. Moisture may be provided through the use of hot water in the vicinity of the application surface 401. In some embodiments, moisture may be in the form of humidity which may be provided by a sink or shower utilizing hot water which may be between 90 to 212 degrees Fahrenheit, in a vicinity of within fifteen feet of the application surface such as in a bathroom or kitchen. In some embodiments, humidity may be provided by steam generators such as used in commercial and residential steam showers, spas, and saunas. When exposed to moisture, water repellant surface tension modifier agents may visually appear by causing the moisture that has condensed on the surface tension modifier agent to appear less transparent, whiter and/or brighter when refracting or reflecting light. When not exposed to moisture, areas of a surface to which a water repellant surface tension modifier agent has been applied may not be visible or distinguishable from areas of a surface to which the agent has not been applied. Examples of water repellant surface tension modifier agents may include silicone, hydrolyzed polydimethylsiloxane, chlorotrimethylsilane, isobutyltrimethoxysilane, monomeric alkylalkoxysiloxane, other organosilanes polysiloxanes, hydroxy-terminated polydimethylsiloxane, dimethylsiloxane (DMS) and DMS capped silicone films, Silica and silane containing formulations, Siloxanes and silicon oils, Diamond-Like Carbons, Polymers and Multi-Polymers, Petroleum distillates, Liquid plastics, Acrylics, Resins-thermoplastic and others, Alcohols, Esters, Ethers, Copolymers, Oligomers, Ethoxys, Acetoxys, Acetates, solid waxes, liquid waxes, solid, liquid, and/or gas forms of other hydrophobic substances or any other water repellant material that may be applied to a surface.

In other embodiments, a surface tension modifier agent may comprise anti-fog properties and may be capable of increasing condensed water droplet size or causing sheeting of water on the surface. When exposed to moisture, anti-fog surface tension modifier agents may visually appear on an application surface 401 (FIGS. 3-7) by causing the moisture that has condensed on the surface tension modifier agent to appear more transparent and/or darker when refracting or reflecting light. When not exposed to moisture, areas of an application surface 401 to which an anti-fog surface tension modifier agent has been applied may not be visible or distinguishable from areas of a surface to which the agent has not been applied. Examples of anti-fog surface tension modifier agents may include hydrophilic coatings or polymers, surfactants, or any other anti-fog material that may be applied to a surface.

Once the surface tension modifier agent has been applied to the application surface 401 (FIGS. 3-7) as desired and optionally once the agent has cured or bonded to the surface, the masking portions 302 (FIGS. 4 and 5) may be removed from the surface in step 105. In other embodiments, the masking portions 302 may be removed from the application surface 401 after any desired additional stencils 300 and/or desired additional surface tension modifier agent has been applied through repeating steps 103 through 105. The masking portions 302 may be removed by detaching the adhesive backing of the masking portions 302 from the application surface 401 by physical methods such as peeling, freezing, melting, pressure washing, or other adhesive detaching methods.

In step 106, if additional indicia is desired to be applied or added to the application surface 401 (FIGS. 3-7), the method 100 may continue to step 103 wherein another stencil 300 (FIGS. 3 and 4) may be applied to the application surface 401. In some embodiments, steps 103 through steps 106 may be repeated as many times as needed to apply the desired indicia to the application surface 401. In further embodiments, steps 103 through steps 106 may be repeated with different surface tension modifier agents which may comprise different condensed water droplet size properties and result in different visual properties of an application surface 401 comprising a surface tension modifier agent, such as lighter and darker areas of indicia, upon exposure to moisture. In other embodiments, the steps 103 through steps 106 may be repeated with different surface tension modifier agents which may comprise different condensed water droplet size properties and result in different visual properties between the surfaces comprising different surface tension modifier agents.

If additional indicia is not to be added to the surface, excess surface tension modifier agent may be removed from the application surface 401 (FIGS. 3-7) in step 107. By removing excess surface tension modifier agent, the ability of an observer to see the surface tension modifier agent once it has cured on the application surface 401 may be hindered or prevented. In some embodiments, the excess surface tension modifier agent may be removed from the surface by wiping off with an absorbent object, such as a cloth or sponge, any surface tension modifier agent that has not bonded or cured to the application surface 401.

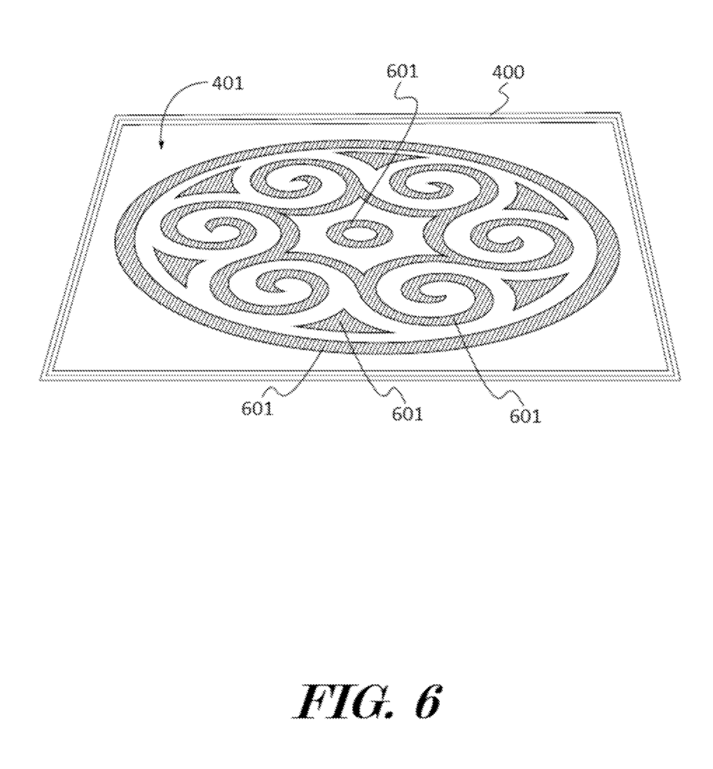

In step 108, the application surface 401 (FIGS. 3-7) may be polished with a polishing compound. In some embodiments, the entire application surface 401 including the areas comprising cured surface tension modifier agent 601 (FIG. 6) may be polished with an ultra fine (ISO/FEPA Grit designations P1500, P2000, P2500, P3000, P6000), super fine (ISO/FEPA Grit designations P800, P1000, P1200), or extra fine (ISO/FEPA Grit designations P400, P500, P600) grade polishing compound. In further embodiments, 3M Finesse-it Polish 28696 or any other similar polishing compound may be used to polish the application surface 401 and/or areas comprising cured surface tension modifier agent 601. In still further embodiments, the polishing compound may be applied to the application surface 401 and/or areas comprising cured surface tension modifier agent 601 with an air, electric, or the like type buffer equipped with foam, wool, or any other suitable type of buffing pads. Once the areas comprising cured surface tension modifier agent 601 and/or the application surface 401 has been polished, the residual polishing compound may be removed from the areas comprising cured surface tension modifier agent 601 and/or application surface 401 with a method common to the type of polishing compound used and the method 100 may finish 109.

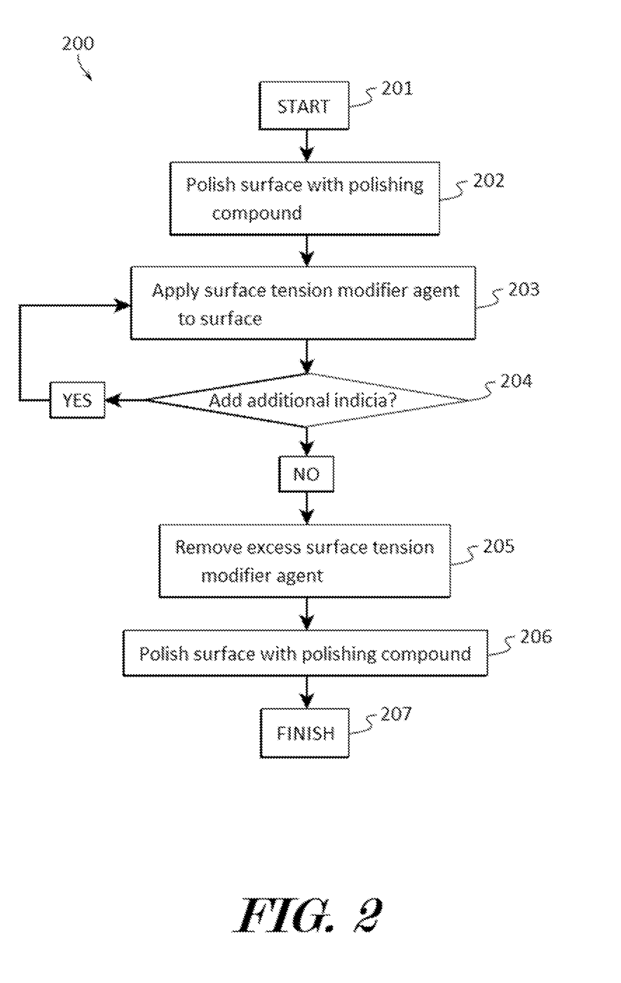

FIG. 2 illustrates a flowchart of an example of a method for moisture revealed indicia application for glass and other surfaces (“the method”) 200 according to various embodiments. In this example, the method 200 does not require a stencil 300 (FIGS. 3 and 4) to be used to apply moisture revealed indicia to an application surface 401. The method 200 may start 201 once an application surface 401 (FIGS. 3-7) is selected for indicia application. Next, the application surface 401 may be optionally polished with a polishing compound in step 202. In some embodiments, the application surface 401 may be polished with an ultra fine or extra fine grade polishing compound. In further embodiments, 3M Finesse-it Polish 28696 or any other similar polishing compound may be used to polish the application surface 401. In still further embodiments, the polishing compound may be applied to the application surface 401 with an air, electric, or the like type buffer equipped with foam, wool, or any other suitable type of buffing pads. Once the application surface 401 has been polished, the residual polishing compound may be removed from the application surface 401 common to the type of polishing compound used.

In step 203, a surface tension modifier agent may be applied onto desired areas of the application surface 401. The surface tension modifier agent may be applied free hand by an applicator 500 (FIG. 5) such as a pen, brush, marker, rubbing cloth, rubbing pad, or other implement or by a mechanical method such as an ink pad type of device, ink jet type applicator or printer, air brush sprayer, lamination, or any other application method.

In step 204, if additional indicia is desired to be applied or added to the application surface 401 (FIGS. 3-7), the method 200 may continue to step 203 wherein additional surface tension modifier agent may be applied to the application surface 401. In some embodiments, steps 203 through step 204 may be repeated as many times as needed to apply the desired indicia to the application surface 401. In further embodiments, step 203 through step 204 may be repeated with different surface tension modifier agents which may comprise different condensed water droplet size properties and result in different visual properties of an application surface 401 comprising a surface tension modifier agent, such as lighter and darker areas of indicia, upon exposure to moisture. In other embodiments, the steps 203 and 204 may be repeated with different surface tension modifier agents which may comprise different condensed water droplet size properties and result in different visual properties of a surface comprising a surface tension modifier agent, such as indicia appearing or disappearing, in response to different humidity levels and temperatures.

If additional indicia is not to be added to the surface, excess surface tension modifier agent may be removed from the application surface 401 (FIGS. 3-7) in step 205. By removing excess surface tension modifier agent, the ability of an observer to see the surface tension modifier agent once it has cured on the application surface 401 may be hindered or prevented. In some embodiments, the excess surface tension modifier agent may be removed from the surface by wiping off with an absorbent object, such as a cloth or sponge, any surface tension modifier agent that has not bonded or cured to the application surface 401.

In step 206, the application surface 401 (FIGS. 3-7) may be polished with a polishing compound. In some embodiments, the entire application surface 401 including the areas comprising cured surface tension modifier agent 601 (FIG. 6) may be polished with an ultra fine or extra fine grade polishing compound. In further embodiments, 3M Finesse-it Polish 28696 or any other similar polishing compound may be used to polish the application surface 401 and/or areas comprising cured surface tension modifier agent 601. In still further embodiments, the polishing compound may be applied to the application surface 401 and/or areas comprising cured surface tension modifier agent 601 with an air, electric, or the like type buffer equipped with foam, wool, or any other suitable type of buffing pads. Once the and/or areas comprising cured surface tension modifier agent 601 and optionally the application surface 401 has been polished, the residual polishing compound may be removed from the areas comprising cured surface tension modifier agent 601 and/or application surface 401 with a method common to the type of polishing compound used and the method 200 may finish 207.

Turning now to FIG. 3, a perspective view of an example of a stencil 300 applied to a pane of glass 400 comprising a substantially transparent application surface 401 according to various embodiments described herein is shown. In this example, the application surface 401 is formed on a pane of glass 400 such as is used to form a glass mirror that may optionally be removed from a door or a wall during application of surface tension modifier agents. In other embodiments, a surface tension modifier agent may be applied to substantially transparent or translucent application surface in situ.

FIG. 4 depicts a perspective view of an example of the stencil backing 301 of the stencil 300 being removed from a substantially transparent application surface 401 according to various embodiments described herein. In this embodiment, the stencil 300 comprises masking portions 302 that are configured to be temporarily adhered to the application surface 401. The stencil 300 also comprises a stencil backing 301 onto which the masking portions 302 may be releasably positioned. Once in contact with the application surface 401, the masking portions 302 may adhere to the application surface 401. The stencil backing 301 may then be removed while leaving the masking portions 302 adhered to the application surface 401. By removing the stencil backing 301, areas of the application surface 401 may be left exposed and able to be contacted by a surface tension modifier agent.

FIG. 5 illustrates a perspective view of an example of an application of surface tension modifier agent to exposed areas 402 of an application surface 401 and optionally over the masking portions 302 of a stencil 300 (FIGS. 3 and 4) according to various embodiments described herein. In this embodiment, surface tension modifier agent may be applied to an applicator 500 such as a cloth, sponge, and the like. The applicator 500, comprising surface tension modifier agent, such as polysiloxanes, hydroxy-terminated polydimethylsiloxane, liquid silicone, and the like, may then be rubbed or dabbed onto exposed areas 402 which are desired to have different moisture adherent properties than the areas of the application surface 401 that will not receive a liquid surface tension modifier agent such as those coved by a masking portion 302. In alternative embodiments, two or more different liquid surface tension modifier agents may be applied to the same or different exposed areas 402 of the of the application surface 401.

FIG. 6 shows a perspective view of an example of cured surface tension modifier 601 which gas bonded to an application surface 401 according to various embodiments described herein. In this example, the masking portions 302 (FIGS. 4 and 5) of the stencil 300 (FIG. 3) have been removed. In some embodiments, excess cured surface tension modifier 601 may be removed by polishing the excess surface tension modifier 601 off with a polishing compound such as an ultra fine grade polishing compound or any other similar polishing compound. A polishing or buffing wheel, polishing or buffing cloth, polishing or buffing pad, and the like may be used to apply the polishing compound which may be used to rub away excess cured surface tension modifier 601, thereby smoothing the cured surface tension modifier 601 adhered to the application surface 401 to a similar degree as the smoothness and visual appearance of the application surface 401. In further embodiments, excess cured surface tension modifier 601 may be removed until a layer with a thickness of approximately 25 or less microns of cured surface tension modifier 601 is left adhered to the application surface 401. In still further embodiments, excess cured surface tension modifier 601 may be removed until a layer with a thickness of approximately 10 or less microns of cured surface tension modifier 601 is left adhered to the application surface 401. In even further embodiments, excess cured surface tension modifier 601 may be removed until a layer with a thickness of approximately 1 or less microns of cured surface tension modifier 601 is left adhered to the application surface 401. In still further embodiments, excess cured surface tension modifier 601 may be removed until a layer with a thickness of approximately one to fifteen molecules of cured surface tension modifier 601 is left adhered to the application surface 401.

In some embodiments, excess cured surface tension modifier 601 may be removed to hinder the ability of an observer to see the cured surface tension modifier 601 on the application surface 401 when the surface is not exposed to moisture. In still other embodiments, excess cured surface tension modifier 601 may not be readily apparent on the application surface 401 to an observer when the surface is not exposed to moisture and therefore may not need to be removed or polished.

FIG. 7 shows a perspective view of an example a moisture revealed indicia system 150 with indicia 700 appearing on a substantially transparent application surface 401 exposed to moisture according to various embodiments described herein. In this example moisture may condense differently onto areas of the application surface 401 that comprising cured surface tension modifier agent 601, compared to the condensing of moisture on areas of the application surface 401 that have not been coated with one or more surface tension modifier agents.

In some embodiments as shown in FIG. 7, moisture condensate may appear darker on areas of the application surface 401 that have not been coated with one or more surface tension modifier agents, while moisture condensate may appear brighter on areas of the application surface 401 that have been coated with one or more surface tension modifier agents. In alternative embodiments, moisture condensate may appear lighter on areas of the application surface 401 that have not been coated with one or more surface tension modifier agents, while moisture condensate may appear darker on areas of the application surface 401 that have been coated with one or more surface tension modifier agents.

Therefore, portions of indicia may be formed by the moisture revealed contrast between one or more areas of the application surface 401 that have been coated with one or more surface tension modifier agents against areas of the application surface 401 that have not been coated with one or more surface tension modifier agents.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A method for applying moisture revealed indicia to portions of a surface, the method comprising:
polishing a surface;
changing the moisture condensing properties of portions of the surface by applying a surface tension modifier agent to those portions of the surface; and
polishing the portions of the surface to which the surface tension modifier agent has been applied.

2. The method according to claim 1, wherein the surface tension modifier agent is water repellent.

3. The method according to claim 2, wherein the surface tension modifier agent is selected from the group consisting of hydrolyzed polydimethylsiloxane, chlorotrimethylsilane, isobutyltrimethoxysilane, monomeric alkylalkoxysiloxane, polysiloxanes, and, dimethylsiloxane.

4. The method according to claim 2, wherein the surface tension modifier agent is selected from the group consisting of silicone, polysiloxanes, hydroxy-terminated polydimethylsiloxane, dimethylsiloxane (DMS) capped silicone films, Silica and silane containing formulations, Siloxanes and silicon oils, Diamond-Like Carbons, Polymers and Multi-Polymers, Petroleum distillates, Liquid plastics, Acrylics, Resins-thermoplastic and others, Alcohols, Esters, Ethers, Copolymers, Oligomers, Ethoxys, Acetoxys, Acetates, solid waxes, and liquid waxes.

5. The method according to claim 1, wherein the surface comprises a substantially transparent material selected from the group consisting of substantially transparent glass, substantially transparent plastics, and substantially transparent resins.

6. The method according to claim 1, wherein the surface comprises a material selected from the group consisting of stone, ceramic, wood, metal, colored glass, frosted glass, translucent glass, translucent plastics, and colored translucent plastics.

7. The method according to claim 1, wherein the surface is polished with a polish with an ISO/FEPA Grit designation of P600 to P6000.

8. The method according to claim 1, wherein portions of the surface to which the surface tension modifier agent has been applied are polished with a polish with an ISO/FEPA Grit designation of P600 to P6000.

9. The method according to claim 1, further comprising the step of introducing moisture to the surface in the form of steam generated by the use of hot water in the vicinity of the surface.

10. The method according to claim 1, further comprising the step of introducing moisture to the surface in the form of steam generated by a steam generator.

11. A method for applying moisture revealed indicia to portions of a surface, the method comprising:
polishing a surface;
masking portions of the surface from contact with a surface tension modifier agent;
changing the moisture condensing properties of portions of the surface by applying a surface tension modifier agent to those portions of the surface; and
polishing the portions of the surface to which the surface tension modifier agent has been applied.

12. The method according to claim 11, wherein the surface tension modifier agent is water repellant.

13. The method according to claim 12, wherein the surface tension modifier agent is selected from the group consisting of hydrolyzed polydimethylsiloxane, chlorotrimethylsilane, isobutyltrimethoxysilane, monomeric alkylalkoxysiloxane, polysiloxanes, and, dimethylsiloxane.

14. The method according to claim 12, wherein the surface tension modifier agent is selected from the group consisting of silicone, polysiloxanes, hydroxy-terminated polydimethylsiloxane, dimethylsiloxane (DMS) capped silicone films, Silica and silane containing formulations, Siloxanes and silicon oils, Diamond-Like Carbons, Polymers and Multi-Polymers, Petroleum distillates, Liquid plastics, Acrylics, Resins-thermoplastic and others, Alcohols, Esters, Ethers, Copolymers, Oligomers, Ethoxys, Acetoxys, Acetates, solid waxes, and liquid waxes.

15. The method according to claim 11, wherein the surface comprises a substantially transparent material selected from the group consisting of substantially transparent glass, substantially transparent plastics, and substantially transparent resins.

16. The method according to claim 11, wherein the surface comprises a material selected from the group consisting of stone, ceramic, wood, metal, colored glass, frosted glass, translucent glass, translucent plastics, and colored translucent plastics.

17. The method according to claim 11, wherein the surface is polished with a polish with an ISO/FEPA Grit designation of P600 to P6000.

18. The method according to claim 11, wherein portions of the surface to which the surface tension modifier agent has been applied are polished with a polish with an ISO/FEPA Grit designation of P600 to P6000.

19. The method according to claim 11, further comprising the step of introducing moisture to the surface in the form of steam generated by the use of hot water in the vicinity of the surface.

20. The method according to claim 1, further comprising the step of introducing moisture to the surface in the form of steam generated by a steam generator.
